(19) United States
(12) Patent Application Publication
(10) Pub. No.: US 2008/0104512 A1
(43) Pub. Date: May 1, 2008

(54) METHOD AND APPARATUS FOR PROVIDING REALTIME FEEDBACK IN A VOICE DIALOG SYSTEM

(75) Inventors: Mark A. Tarlton, Barrington, IL (US); Thomas J. Mactavish, Inverness, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/554,839

(22) Filed: Oct. 31, 2006

(51) Int. Cl. G06F 3/048

(52) U.S. Cl. 715/706

(57) ABSTRACT

A method and apparatus for providing feedback to the user of a voice dialog system. The apparatus includes a voice dialog processing module for receiving speech input from a user and conducting a dialog with the user. The voice dialog processing module determines dialog status data and passes it to a status processing module which determines a facial or body expression corresponding to the dialog status data. An avatar display device displays to the user an avatar that depicts the facial or body expression.

### FIELD OF THE INVENTION

The present invention relates generally to voice dialog systems.

### BACKGROUND

Voice-based interaction with PC's and mobile devices is becoming more widespread and the mobile devices are able to accept longer, and more complex, speech expressions. However, when errors occur in speech input, the user is often not informed of the problem until he or she has completely finished speaking and is not provided adequate information as to where the problem occurred. As a result, the user is often required to repeat long commands or try to reword inputs, without adequate information as to where the misunderstanding occurred, in order to make the speech input understood.

In previous voice input systems, processing of a speech utterance begins after the utterance is complete. These systems do not provide real-time feedback to the end user. Instead, feedback and recovery from errors is addressed in terms of dialog, as described above. Adaptive natural language processing systems can change operation in response to inputs, but they do not address real-time feedback related to speech understanding. Although these systems are able to process the speech inputs in real-time, error recovery is addressed only in terms of a response that follows a complete utterance, rather than real-time feedback.

Other voice dialog system use ‘barge-in’ responses, where the system immediately interrupts the user when the recognition processing fails. However, these systems are perceived by users as being rude and do not enable normal dialog recovery processes, such as in-context repetition or rewording of commands.

Some voice output systems that use avatars synchronize motion of the avatar with the output speech, so as to give the impression that the avatar is producing the speech (as in a cartoon).

### BRIEF DESCRIPTION OF THE FIGURES

The accompanying figures, in which like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an example apparatus in accordance with some embodiments of the invention.

FIG. 2 is a flow chart of an example method in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to the provision of visual feedback to a user of a voice dialog system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions related to the provision of visual feedback to a user of a voice dialog system described herein. The non-processor circuits may include, but are not limited to, audio input and output devices, signal conditioning circuit, graphical display units, etc. As such, these functions may be interpreted as a method to perform visual feedback to the user. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

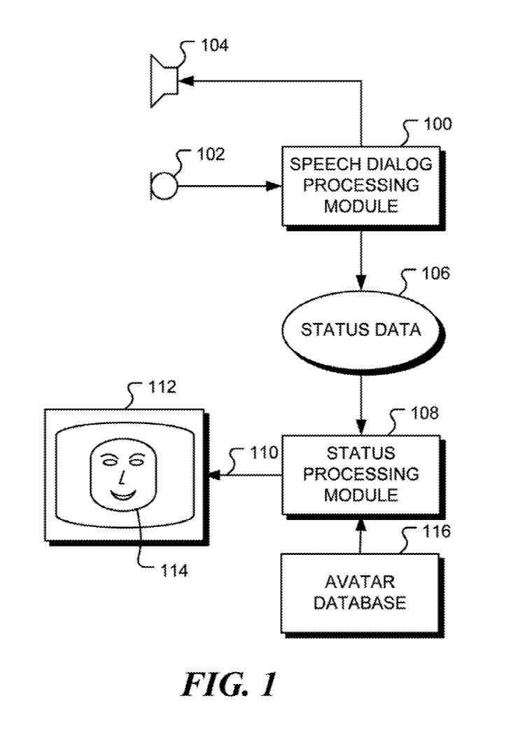

FIG. 1 is a block diagram of an example apparatus consistent with certain embodiments of the invention. The apparatus includes a voice dialog processing module 100 that processes user voice input from a speech input device, such as microphone 102 or video lip reader. The voice processing module may be a programmed processor, for example. The voice dialog processing module 100 generates speech outputs, such as prompts, that are passed to an audio output device, such as loudspeaker 104. Standard signal conditioning such signal amplification, signal filtering, analog-to-digital and digital-to-analog filtering is omitted from diagram for clarity. The voice dialog processing module 100 is operable to process the speech inputs in near real-time and provides information 106 as to its status in recognizing and understanding the user's speech. A status processing module 108 monitors the dialog status data and produces an interpretation 110 of the status. This interpretation 110 is used to drive an avatar display device 112 to display an avatar 114 that exhibits an expression corresponding to the interpretation of the status. The avatar may be an animated graphical representation of a face that is capable of expressing a range of facial expressions or a complete or partial body of a person that is capable of adopting various body poses to convey expressions using body language. The status processing module 108 executes concurrently with the speech processing and communicates its ongoing status to the avatar display device.

Multiple avatars, or the parameters that specify them, may be stored in a database or memory 116. The avatars may be selected according the voice dialog application being executed or according to the user of the voice dialog system.

Facial expressions and/or body poses (body expressions) depicted by the avatar are used to communicate, in real-time, the ongoing status of the voice input processing. For example, different facial expressions and/or body poses may be used to indicate, for example: (1) that the system is in an idle mode, (2) that the system is actively listening to the user, (3) that processing is proceeding normally and with adequate confidence levels, (4) that processing is proceeding but confidence measures are below some system threshold—a potential misunderstanding has occurred, (5) that errors have been detected and the user should perform a recovery process, such as repeating the voice utterance, (6) that a non-recoverable failure has occurred, or (7) that the system desires an opportunity to respond to the user.

The apparatus provides real-time feedback to a user regarding speech recognition in a natural, user-friendly manner. This feedback may provided both when a new state is entered and within a state. Feedback within a state may be used to convey a sense of ‘liveness’ or ‘awareness’ to the user. This may advantageous during a listening state, for example.

In some embodiments, an avatar that gives an appearance of listening is used so as to make voice interaction with a dialog system more comfortable for a user.

In some embodiments, different avatars are used to represent different applications that the user is interacting with, or to indicate personalization (i.e., each individual user has their own avatar. Presence of a user's personal avatar indicates that the voice dialog system recognizes who's speaking and that personalization factors may be used. Data representing the different avatars may be stored in a computer memory, for example.

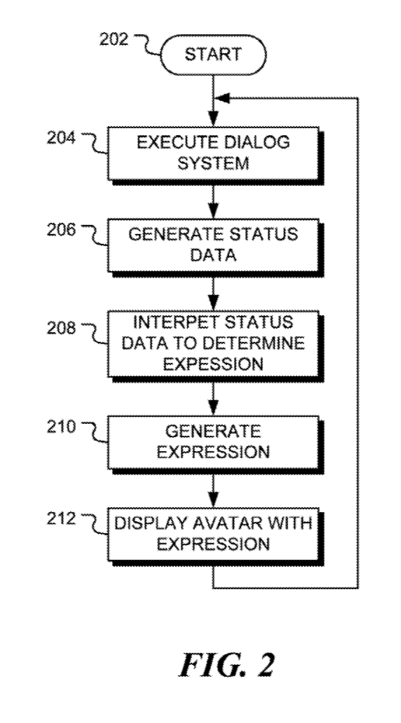

FIG. 2 is a flow chart of a method in accordance with certain embodiments of the invention. Following start block 202 in FIG. 2, the voice dialog system is executed at block 204. The dialog system may prompt the user with visual or audio prompts and respond to audio inputs from the user. At block 206, the voice dialog processor generates status information relating to the current state of the dialog. Example states include, but are not limited to: (1) the system is in an idle mode, (2) the system is actively listening to the user, (3) processing is proceeding normally and with adequate confidence levels, (4) processing is proceeding but confidence measures are below some system threshold—a potential misunderstanding has occurred, (5) errors have been detected and the user should perform a recovery process, such as repeating the voice utterance, (6) that a non-recoverable failure has occurred, or (7) the system desires an opportunity to respond to the user. At block 208, the status processing module interprets the status data to determine an appropriate avatar facial or body expression. The graphical representation of the facial or body expression is generated at block 210 and displayed on a visual display at block 212.

The avatar provides rapid feedback to the user, without interfering with the flow of speech and helps to mediate dialog flow. This can avoid the need for a user to repeat long segments of speech. Additionally, the avatar enables the user to easily discern if the dialog system is attentive.

The dialog status data may be representative, for example, of an idle state, an actively listening state, a normal operation state (with confidence above a threshold), a normal operation state (with confidence below a threshold), a recoverable error state, a non-recoverable failure state or a system response requested state.

The avatar expression may be designed to correspond to those that commonly mediate person-person conversation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A voice dialog system operable to provide visual feedback to a user, the voice dialog system comprising:
a voice dialog processing module operable to receive speech input from a user and execute a dialog with the user, the voice dialog processing module further operable to determine dialog status data;
a status processing module, responsive to the dialog status data and operable to determine an expression corresponding to the dialog status data; and
an avatar display device, operable to display to the user an avatar that depicts the expression.

2. A voice dialog system in accordance with claim 1, further comprising:
a speech input unit, operable to sense user speech and provide it to the voice dialog processing module; and
a speech output unit, operable to convert a speech signal from the voice dialog processing module to an audio signal.

3. A voice dialog system in accordance with claim 1, wherein the avatar comprises a graphical representation of a face that is capable of expressing a range of facial expressions.

4. A voice dialog system in accordance with claim 1, wherein the avatar comprises a graphical representation of a person that is capable of expressing a range of body poses.

5. A voice dialog system in accordance with claim 1, wherein the dialog status data is related to voice dialog system's status in recognizing and understanding the user's speech.

6. A voice dialog system operable to provide visual feedback to a user, the voice dialog system comprising:
a means for processing a voice input from a user of the voice dialog system;
a means for determining dialog state data related to a current state of a voice dialog; and
a means for displaying an avatar to the user in response to the dialog state data, the avatar depicting an expression consistent a current state of the voice dialog.

7. A voice dialog system in accordance with claim 6, wherein the avatar comprises a graphical representation of a face.

8. A voice dialog system in accordance with claim 6, wherein the avatar comprises a graphical representation of a person.

9. A voice dialog system in accordance with claim 6, further comprising a means for sensing the user's voice to produce the voice input.

10. A voice dialog system in accordance with claim 6, further comprising a means for generating an audio output to user.

11. A voice dialog system in accordance with claim 6, further comprising a means for storing a plurality of avatar representations.

12. A method for providing visual feedback to a user of a voice dialog system, the method comprising:
generating dialog status data corresponding to a current state of the voice dialog;
interpreting the dialog status data to determine an expression corresponding to the current state of the voice dialog;
generating a graphical representation of the expression; and
displaying the graphical representation of the expression to the user of the voice dialog system.

13. A method in accordance with claim 12, wherein the graphical representation of the expression is an avatar displayed on a display unit.

14. A method in accordance with claim 13, further comprising:
receiving a voice input from a user of the voice dialog system;
recognizing the identify of the user;
selecting the avatar in accordance with the identity of the user.

15. A method in accordance with claim 12, wherein the dialog status data is representative of the system's status in recognizing and understanding the user's speech.

16. A method in accordance with claim 12, wherein the dialog status data is representative of a state selected from the group of states consisting of:
an idle state an actively listening state;
a normal operation state, with confidence above a threshold;
a normal operation state, with confidence below a threshold;
a recoverable error state;
a non-recoverable failure state; and

17. A method in accordance with claim 12, wherein generating the graphical representation of the expression is dependent upon the voice dialog application being executed.

18. A method in accordance with claim 12, wherein the graphical representation of the expression comprises a graphical representation of a face.

19. A method in accordance with claim 12, wherein the graphical representation of the expression comprises a graphical representation of a person.
